(19) United States
(12) Patent Application Publication
(10) Pub. No.: US 2008/0230963 A1
(43) Pub. Date: Sep. 25, 2008

(54) Method of manufacturing low temperatue co-firing substrate

(75) Inventor: Je Hong Sung, Hwasung (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/076,573

(22) Filed: Mar. 20, 2008

(30) Foreign Application Priority Data
Mar. 22, 2007 (KR) 2007-28231

(51) Int. Cl. B28B 3/00

(52) U.S. Cl. 264/642

(57) ABSTRACT

There is provided a method of manufacturing an LTCC substrate, capable of enhancing coatability of an external electrode pad, yield of the LTCC substrate as a package and product reliability and ensuring compactness of a product utilizing the LTCC substrate package. The method includes: forming a cavity on external electrode pad forming layers, respectively and filling the cavity with an external electrode pad material; depositing the external electrode pad forming layers on a ceramic stack with a printed circuit pattern formed therein; and sintering the ceramic stack having the external electrode pad forming layers deposited thereon at a low temperature.

### CROSS-REFERENCE TO RELATED APPLICATIONS

This application claims the priority of Korean Patent Application No. 2007-28231 filed on Mar. 22, 2007, in the Korean Intellectual Property Office, the disclosure of which is incorporated herein by reference.

### BACKGROUND OF THE INVENTION

1. Field of the Invention

The present invention relates to a method of manufacturing a low-temperature co-firing ceramic (LTCC) substrate, more particularly, to a method of manufacturing an LTCC substrate, capable of enhancing coatability of an external electrode pad, yield of the LTCC substrate as a package and product reliability and ensuring compactness in a product utilizing the LTCC substrate package.

2. Description of the Related Art

Recently, with an increasingly smaller and more harsh environmental requirement trend of the mobile and automotive electronic parts field, electronic parts have been more precise, more minutely patterned and thinner, leading to development of a more reliable module and substrate. However, a general printed circuit board (PCB), when used in such more compact electronic products, entails drawbacks associated with the small size, and experiences loss of a signal at a high frequency region and less reliability in a high temperature and high humidity environment.

To overcome these drawbacks, a ceramic substrate in place of the PCB substrate is employed. The ceramic substrate, when mainly formed of a ceramic composition containing a great amount of glass capable of being sintered at a low temperature, is classified as a low temperature co-fired ceramic (LTCC) substrate.

The LTCC substrate can be manufactured in various methods, which include constrained sintering and non-constrained sintering according to contractability of the substrate during sintering. The LTCC substrate is generally free-sintered at a temperature of about 800° C. to 1000° C., in which ceramic is typically contracted by about 14% in xy-direction. Accordingly, by the non-constrained sintering, the substrate is contracted during the sintering and by the constrained sintering, the substrate is sintered using an additional method to prevent contraction of the ceramic.

In the case of the constrained sintering, the substrate is prevented from contraction by forming and sintering confinement layers on both surfaces of the substrate having a printed circuit pattern formed therein. The confinement layers are formed of a material which is not contracted at a sintering temperature of the substrate but easily controls contraction.

FIG. 1 illustrates a cross-sectional view illustrating an LTCC substrate having external electrode pads formed thereon according to conventional non-constrained sintering. The LTCC substrate includes a ceramic stack 10 and external electrode pads 12a and 12b formed on both surfaces of the ceramic stack 10. A printed circuit pattern (not shown) is formed in the ceramic stack 10.

To form the ceramic stack 10, the printed circuit pattern is formed on a green sheet formed of a ceramic material capable of being sintered at a low temperature and the plurality of green sheets are stacked in multi-layers. The ceramic stack 10, when provided, has the external electrode pads 12a and 12b formed on a top and bottom thereof to mount necessary devices thereon, respectively. After the forming of the external electrode pads 12a and 12b, the ceramic stack 10 is sintered at a low temperature and the LTCC substrate is produced. Here, the ceramic stack 10 is typically contracted by about 14% depending on sintering.

Here, when the ceramic stack 10 undergoes sintering, the ceramic stack 10 and the external electrode pads 12a and 12b are formed of materials different from each other and thus sintered under different mechanisms. Also, after the sintering, the ceramic stack 10 and the external electrode pads 12a, and 12b have a weak contact surface therebetween due to differences in thermal expansion coefficient between the ceramic and metal of the external electrode pads.

Meanwhile, FIGS. 2A to 2D illustrate a method of manufacturing an LTCC having external electrode pads formed according to the constrained sintering. First, as shown in FIG. 2A, a ceramic stack 20 having a printed circuit pattern formed therein is provided. Here, to prevent the ceramic stack 20 from contracting, confinement layers 21a and 21b are deposited on a top and bottom of the ceramic stack 20 as shown in FIG. 2B. The confinement layers 21a and 21b are formed of a material capable of controlling contraction of the ceramic stack 20 at a sintering temperature of the LTCC substrate.

After the depositing of the confinement layers 21a, and 21b, the ceramic stack 20 is sintered at a low temperature, and after the sintering, the confinement layers 21a and 21b are removed by grinding and the like as shown in FIG. 2c. With the confinement layers 21a and 21b removed, external electrode pads 22a and 22b are formed on the sintered ceramic stack 20.

However, the external electrode pads 22a and 22b formed as shown in FIG. 2 are more weakly bonded to the ceramic stack 20 compared to the sintering method of FIG. 1. In manufacturing the LTCC substrate for an electronic device package, precise size and location and flat patterns are considerably important for reliability of the devices attached onto the substrate when the devices are surface-mounted by surface mount technology, wire bonding or flip-chip bonding. Notably, the bonded strength and flatness of the external electrode pads are considered greatly important for reliability of the module. Therefore, the external electrode pads formed by the conventional method are variously problematic.

As a result, there has been a demand for a technology of bonding the external electrode pads to the ceramic stack more reliably when manufacturing the LTCC substrate using constrained or non-constrained sintering.

### SUMMARY OF THE INVENTION

An aspect of the present invention provides a method of manufacturing an LTCC substrate, capable of enhancing coatability of an external electrode pad, yield of the LTCC substrate as a package and product reliability and ensuring compactness in a product utilizing the LTCC substrate package.

According to an aspect of the present invention, there is provided a method of manufacturing a low-temperature co-fired ceramic substrate, the method including: forming a cavity on external electrode pad forming layers, respectively and filling the cavity with an external electrode pad material; depositing the external electrode pad forming layers on a ceramic stack with a printed circuit pattern formed therein; and sintering the ceramic stack having the external electrode pad forming layers deposited thereon at a low temperature.

The cavity may be formed by punching. The external electrode pad material may be one selected from a group consisting of Ag, Au, Cu, Pd and a combination thereof.

Each of the external electrode pad forming layers may include a cavity forming layer for forming the cavity thereon and a support layer for supporting the cavity forming layer.

The sintering the ceramic stack may be performed at a temperature of 600° C. to 950° C.

According to another aspect of the present invention, there is provided a method of manufacturing a low-temperature co-fired ceramic substrate, the method including: forming a cavity on external electrode pad forming layers, respectively and filling the cavity with an external electrode pad material; depositing the external electrode pad forming layers on a ceramic stack with a printed circuit pattern formed therein; and forming a confinement layer on each of the external electrode pad forming layers; sintering the ceramic stack having the confinement layers formed thereon at a low temperature; and removing the confinement layers form the sintered ceramic stack.

The confinement layer may be formed of a material selected from a group consisting of alumina (Al₂O₃), magnesia (MgO), zirconia (ZrO₂), and titania (TiO₂).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view illustrating a low-temperature co-fired ceramic (LTCC) substrate having external electrode pads formed thereon according to conventional non-constrained sintering;

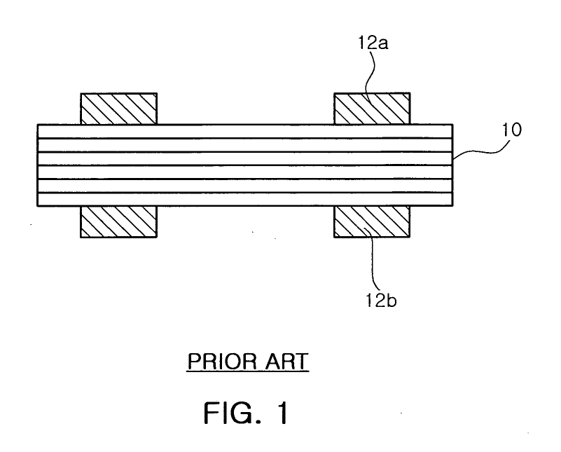

FIGS. 2A to 2D illustrate a method of manufacturing an LTCC substrate according to conventional constrained sintering;

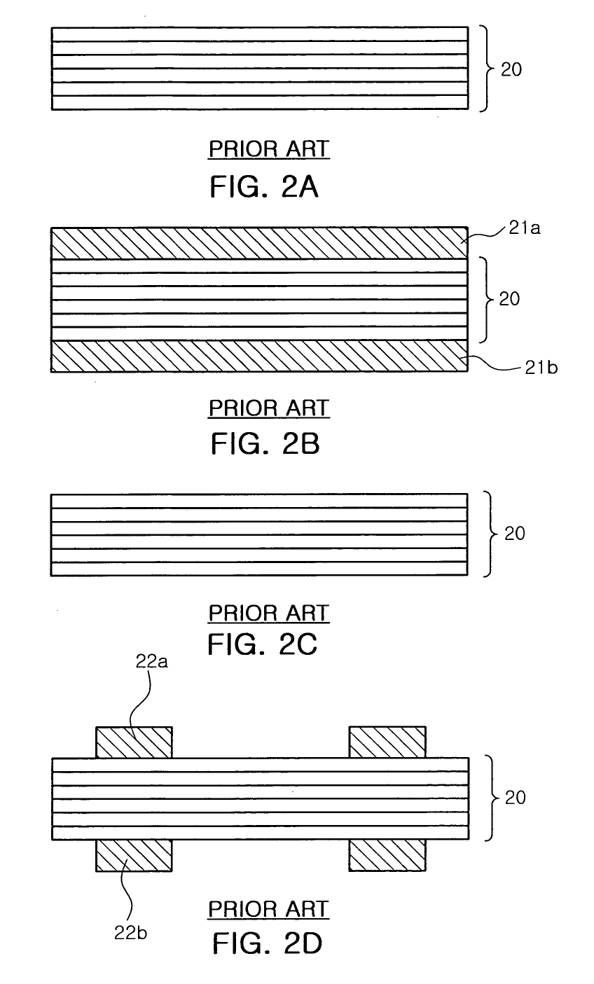

FIGS. 3A to 3D illustrate a method of manufacturing an LTCC substrate having external electrode pads formed thereon according to an exemplary embodiment of the invention; and

FIG. 4 is a cross-sectional view illustrating an LTCC substrate having confinement layers formed on electrode pad forming layers thereof according to another exemplary embodiment of the invention.

### DETAILED DESCRIPTION OF THE PREFERRED EMBODIMENT

Exemplary embodiments of the present invention will now be described in detail with reference to the accompanying drawings. This invention, may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity.

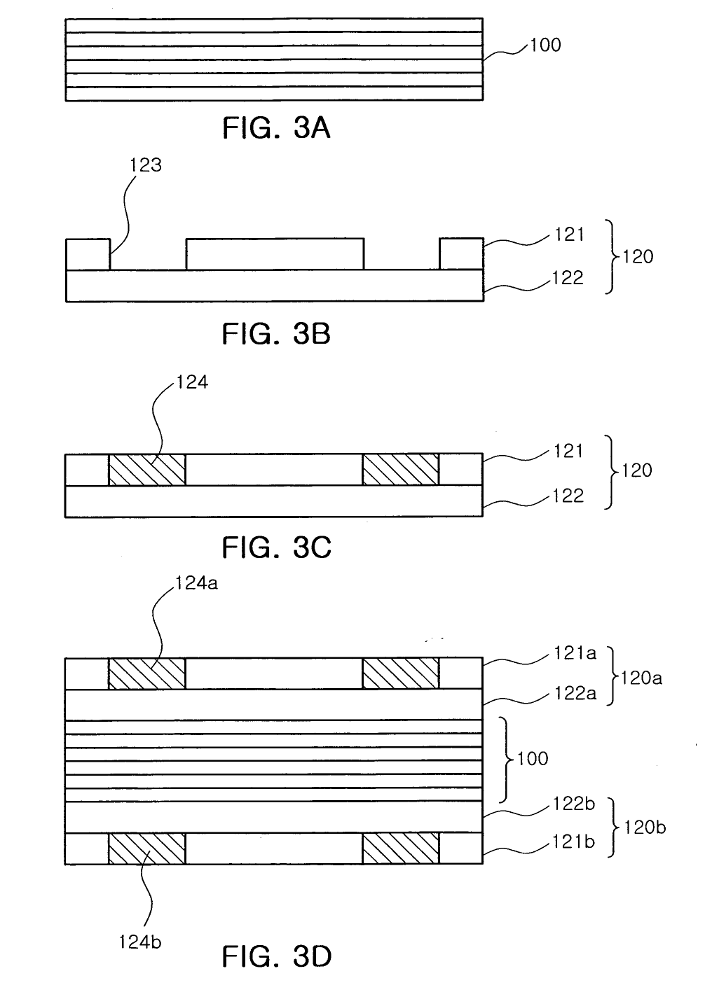

FIGS. 3A to 3D illustrate a method of manufacturing an LTCC substrate having external electrode pads formed thereon according to an exemplary embodiment of the invention. In manufacturing the low temperature co-fired ceramic (LTCC) substrate, first, cavities 123 are formed on an external electrode pad forming layer 120, i.e., each of external electrode pad forming layers 120a and 120b (see FIG. 3D) and filled with an external electrode pad material. Then, the external electrode pad forming layers 120a and 120b are deposited on both surfaces of a ceramic stack 100 having a printed circuit pattern formed therein. Finally, the ceramic stack 100 having the external electrode pad forming layer 120 deposited thereon is sintered at a low temperature.

Referring to FIG. 3A, the stack 100 having green sheets for the LTCC substrate deposited in multi-layers is provided. The green sheets are formed of ceramic capable of being sintered at a low temperature. For example, the green sheets may contain glass ceramic. Also, the green sheets may further contain at least one material of silicon oxide, calcium oxide, and boron oxide powder. To form the green sheets in a sheet shape, the low temperature co-fired ceramic including the aforesaid powder may be mixed with a binder and a plasticizer.

A via (not shown) is formed in the green sheets to form a printed circuit pattern. The via may be formed in an appropriate number. The via (not shown) may be formed by a known method, for example, punching or laser irradiation. As the printed circuit pattern, an internal electrode pad (not shown) other than the via may be formed in a predetermined number. The printed circuit pattern is formed by such known methods as described above and thus will not be explained in greater detail.

Apart from the ceramic stack 100, the external electrode pad forming layer 120 is prepared as shown in FIG. 3b. The external electrode pad forming layer 120 is designed to form the external electrode pads 124a thereon, and 124b, and the external electrode pads 124a, and 124b are designed to mount electronic devices on the LTCC substrate.

Referring to FIG. 3B, the external electrode pad forming layer 120 is formed of two layers, i.e., a cavity forming layer 121 and a support layer 122. The cavities 123 are formed by punching to define the external electrode pads. A depth of each of the cavities 123 from a top surface of the external electrode pad forming layer 120 may be varied in view of size of the LTCC substrate or characteristics of the electronic device to be mounted. For example, the cavity may be 20 μm deep with respect to the surface of the external electrode pad forming layer.

A support layer 122 serves to support the cavity forming layer 121 having the cavity 123 thereon. The support layer 122 may be formed of a ceramic green sheet.

In FIG. 3C, the cavities 123 are filled with the external electrode pad material. The external electrode pad material 124 filled in the cavity 123 may be a conductive material such as Ag, Au, Cu, Pd or a combination thereof.

Referring to FIG. 3D, the external electrode pad forming layers 120a and 120b are deposited on the ceramic stack 100. The ceramic stack 100 having the external electrode pad forming layers 120a and 120b formed thereon is sintered at a low temperature of 600° C. to 950° C.

The external electrode pads of the LTCC substrate manufactured are formed on the external electrode pad forming layers. This allows the pads to be formed flush with the substrate, and increases a contact area therebetween, thereby enhancing bonding strength.

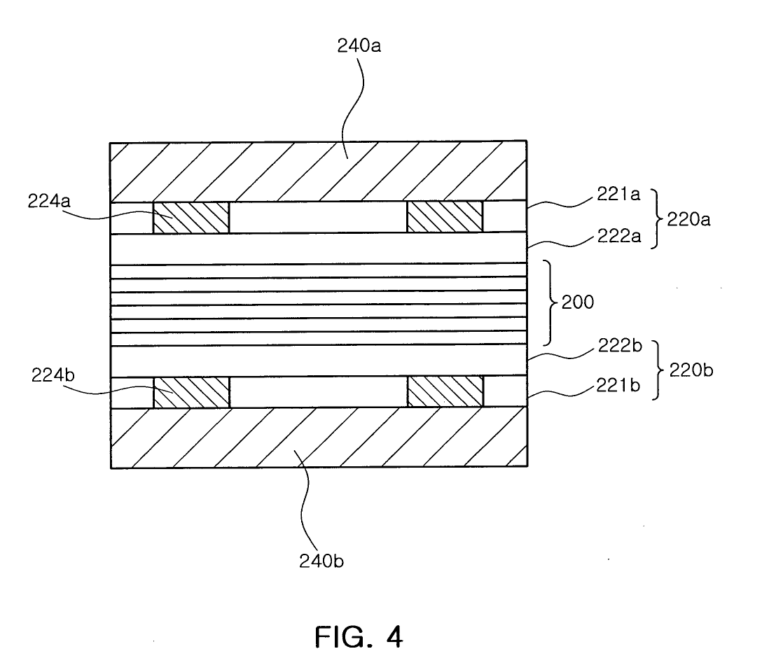

FIG. 4 is a cross-sectional view illustrating an LTCC substrate having confinement layers formed on external electrode pad forming layers, respectively according to another exemplary embodiment of the invention.

According to the present embodiment, to manufacture the LTCC substrate, cavities are formed on external electrode pad forming layers 220a and 220b and filled with an external electrode pad material. Then, the external electrode pad forming layers 220a and 220b are deposited on both surfaces of the ceramic stack 200 having a printed circuit pattern formed therein. Afterwards, confinement layers 240a and 240b are formed on the external electrode pad forming layers 220a and 220b. Also, the ceramic stack 200 having the confinement layers 240a and 240b formed thereon are sintered at a low temperature. Finally, the confinement layers 240a and 240b are removed from the sintered ceramic stack 200.

Referring to FIG. 4, the external electrode pad forming layers 220a and 220b are deposited on the ceramic stack 200, and the confinement layers 240a and 240b are deposited thereon. Here, external electrode pad forming layers 220a and 220b are deposited on the ceramic stack 200 in the same manner as shown in FIGS. 3A to 3D, and thus will not be described in detail.

Referring to FIG. 4, when the external electrode pad forming layers 220a and 220b having the external electrode pads 224a and 224b formed thereon are deposited on the ceramic stack 200, the confinement layers 240a and 240b are deposited on both surfaces of the ceramic stack 200 to ensure constrained sintering. The confinement layers 240a and 240b may be formed of a non-contractible material at a sintering temperature of the green sheets constituting the ceramic stack 200 to control contraction of the substrate during sintering.

Particularly, the confinement layers may be formed of a material having a softening point of 1200° C. to 1500° C. The confinement layers may be formed of an inorganic material selected from one of alumina (Al₂O₃), magnesia (MgO), zirconia (ZrO₂), and titania (TiO₂).

The confinement layers 240a and 240b contain the aforesaid inorganic material as a powder. The powder can be mixed with a solvent and a binder to form sheets. Also, the confinement layers 240a and 240b may further contain a dispersant, a plasitcizer, a parting agent or a stripping agent.

The ceramic stack 200 having the confinement layers 240a and 240b deposited thereon is sintered at a low temperature. A sintering temperature can be set depending on size of the ceramic stack 200, a deposited material and characteristics of a printed circuit pattern. For example, the sintering may be performed at a temperature of 600° C. to 950° C.

The confinement layers 240a and 240b are removed after being completely sintered at a low temperature. The confinement layers 240a and 240b may be removed by grinding, lapping, sandblastering machine, crushing via ultrasonic waves or a combination thereof.

As set forth above, according to exemplary embodiments of the invention, external electrode pads are bonded superbly in manufacturing the LTCC substrate, thus enhancing coatability of the external electrode pads, yield of the LTCC substrate as a package and product reliability.

In addition, the external electrode pads can be formed in a desired position and shape and more flattened at a top surface thereof. This allows devices to be more precisely and solidly mounted on the LTCC substrate, thereby leading to functional integration. This eventually ensures a product adopting the LTCC substrate package of the present invention to be reduced in size and more reliable.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing a low-temperature co-fired ceramic substrate, the method comprising:
forming a cavity on external electrode pad forming layers, respectively and filling the cavity with an external electrode pad material;
depositing the external electrode pad forming layers on a ceramic stack with a printed circuit pattern formed therein; and
sintering the ceramic stack having the external electrode pad forming layers deposited thereon at a low temperature.

2. The method of claim 1, wherein the cavity is formed by punching.

3. The method of claim 1, wherein the external electrode pad material comprises one selected from a group consisting of Ag, Au, Cu, Pd and a combination thereof.

4. The method of claim 1, wherein each of the external electrode pad forming layers comprises a cavity forming layer for forming the cavity thereon and a support layer for supporting the cavity forming layer.

5. The method of claim 1, wherein the sintering the ceramic stack is performed at a temperature of 600° C. to 950° C.

6. A method of manufacturing a low-temperature co-fired ceramic substrate, the method comprising:
forming a cavity on external electrode pad forming layers, respectively and filling the cavity with an external electrode pad material;
depositing the external electrode pad forming layers on a ceramic stack with a printed circuit pattern formed therein; and
forming a confinement layer on each of the external electrode pad forming layers;
sintering the ceramic stack having the confinement layers formed thereon at a low temperature; and
removing the confinement layers form the sintered ceramic stack.

7. The method of claim 6, wherein the confinement layer is formed of a material having a softening point of 1200° C. to 1500° C.

8. The method of claim 6, wherein the confinement layer is formed of a material selected from a group consisting of alumina, magnesia, zirconia, and titania.
